(19) United States
(12) Patent Application Publication
(10) Pub. No.: US 2005/0144469 A1
(43) Pub. Date: Jun. 30, 2005

(54) Imaging apparatus, imaging system, security management apparatus, and security management system

(76) Inventor: Atsuhisa Saitoh, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/988,023

(22) Filed: Nov. 12, 2004

(30) Foreign Application Priority Data
Nov. 14, 2003 (JP) 2003-385462
Nov. 2, 2004 (JP) 2004-319430

(51) Int. Cl. H04L 9/32

(52) U.S. Cl. 713/189

(57) ABSTRACT

An imaging apparatus is provided that is capable of maintaining document security control even in a case where document ID information cannot be identified from a physical document that is subject to an imaging operation. The imaging apparatus includes a read unit for reading image data from a physical document in response to an imaging request from a user, a user information acquisition unit for acquiring user information including a security attribute of the user, a document information acquisition unit for acquiring document information including a security attribute of the physical document, an operating condition selection unit for determining whether to authorize outputting of the image data read from the physical document based on the user information and the document information by referring to a predetermined rule, and a log management unit for storing the image data in association with the user information without allowing the image data to be output when the document information is not acquired at the document information acquisition unit.

The present application claims priority to the corresponding Japanese Patent Application No.2003-385462, filed on Nov. 14, 2003 and Japanese Patent Application No. 2004-319430, filed on Nov. 2, 2004, the entire contents of which are hereby incorporated by reference.

### BACKGROUND OF THE INVENTION

1. Field of the Invention

The present invention relates generally to imaging technology, and particularly to an imaging apparatus and system for enabling reproduction and/or transmission of image information contained in a document under security management while maintaining its original security level. The present invention also relates to security management during an imaging operation.

2. Description of the Related Art

In recent years and continuing, with the proliferation of information devices and the development of networking technology, information network systems that incorporate various imaging apparatus functions such as facsimile, printer, and copier functions are being introduced into offices. Documents necessary for conducting business operations may be output in various formats using facsimile machines, printers, and copiers, for example.

Presently, an increasing number of organizations, particularly in the government and public office sector, are implementing information security policies based on an information security management standard known as ISO 17799. Information systems that are designed to ensure security are being constructed and operated based on such information security policies.

A security policy is normally set in the form of a policy file. Examples of security policies set within a system are information pertaining to execution authorization of a program set in Java (Registered Trademark) or information pertaining to passage authorization of protocols set in firewalls.

With respect to controlling access to a data file, a system is proposed in the prior art (e.g., Japanese Laid-Open Patent Publication No.2001-184264) for evaluating whether conditional access should be allowed. According to this prior art example, when a request for access to a data file is made from the outside, a policy evaluation module extracts a policy description that is associated with the corresponding data to which access is being requested and determines whether the request for access should be granted. In a case where a condition that may not be evaluated based solely on the information held by the policy evaluation module is included in the extracted policy description, an execution function verification module determines whether it can evaluate this condition. If the condition can be evaluated, it may be determined whether the request for access should be granted based on this condition.

The above prior art example provides a method for controlling access to a data file that is stored, but it does not include measures for ensuring security during data processing such as copying or transferring of data to another information device.

In another prior art example, a method is provided for setting a database that stores information pertaining to a security policy and various apparatuses included in a system in association with a management/monitoring program extracting an appropriate management/monitoring program from the database, controlling the system to conform to the policy, and monitoring the conformity state of the system (e.g., Japanese Laid-Open Patent Publication No.2001-273388). According to this method, access control is merely conducted according to programs registered in the system, and thereby, little flexibility is allowed.

In another prior art example, an access control system is provided for preventing illegal access within a client-server system that is interconnected via a network (e.g., Japanese Laid-Open Patent Publication No. 2001-337864). For example, an infiltrator within a network may abuse his/her user authority to illegally access and read a file or attempt to overwrite data in an illegally accessed file. The above method may be used to block such illegal access.

Also, a method for use within a system implemented in an open distributed environment is provided, the method including setting a security policy against a third party organization, updating the security policy, conducting access control between domains according to the security policy, and surveying, analyzing, warning about, and disclaiming security violations (e.g., Japanese Laid-Open Patent Publication No. 7-141296).

In such security measure implementations, the security management administrator needs to have sufficient knowledge of the security policies being individually set in the various information devices. It may also be advantageous to be able to easily grasp the overall security state of the system. However, in the present systems it is quite difficult to grasp the overall security state of the system. In addition, even when security measures are implemented in individual apparatuses, a user is not able to perceive whether the security of a document is being maintained during an imaging operation such as copying or transmission.

Further, measures need to be contemplated for handling cases of processing (such as copying or scanning) a document that is not under any security management setting, or cases in which document information of a document that is under security management cannot be read.

### SUMMARY OF THE INVENTION

Imaging and security apparatuses, systems, and methods are described. In one embodiment, the imaging apparatus comprises a read unit to read image data from a physical document in response to an imaging request from a user, a user information acquisition unit to acquire user information including a security attribute of the user, a document information acquisition unit to acquire document information including a security attribute of the physical document, an operating condition selection unit to determine whether to authorize outputting of the image data read from the physical document based on the user information and the document information by referring to a predetermined rule, and a log management unit to store the image data in association with the user information without allowing the image data to be output when the document information is not acquired at the document information acquisition unit.

### BRIEF DESCRIPTION OF THE DRAWINGS

Other embodiments and further features of the present invention will be apparent from the following detailed description when read in conjunction with the accompanying drawings, in which:

FIG. 1 is a block diagram showing a hardware configuration of an imaging apparatus according to an embodiment of the present invention;

FIG. 2A is a block diagram illustrating an exemplary configuration of an imaging apparatus according to the first embodiment that is applied to a scanner apparatus, and FIG. 2B is a block diagram illustrating an exemplary configuration of an imaging apparatus of the first embodiment that is applied to a copier apparatus;

FIG. 3A is a diagram illustrating a configuration of a document profile acquisition unit according to an embodiment of the present invention, and FIG. 3B is a diagram illustrating a configuration of a document profile acquisition unit according to another embodiment;

FIG. 4 is diagram illustrating a configuration of a user profile acquisition unit according to an embodiment the present invention;

FIG. 5 is a diagram showing an example of a security rule defined in a security rule table according to an embodiment of the present invention;

FIG. 6 is a flowchart illustrating an operation of the imaging apparatus according to the first embodiment;

FIG. 7 is a diagram showing an example of an output image log;

FIG. 8A is a block diagram showing an exemplary configuration of an imaging apparatus according to a second embodiment of the present invention that is applied to a scanner apparatus, and FIG. 8B is a block diagram showing an exemplary configuration of an imaging apparatus of the second embodiment that is applied to a copier apparatus;

FIG. 9 is a diagram showing an example of an output access log;

FIG. 10A is a block diagram showing an exemplary configuration of an imaging apparatus according to a third embodiment of the present invention that is applied to a scanner apparatus, and FIG. 10B is a block diagram showing an exemplary configuration of an imaging apparatus of the third embodiment that is applied to a copier apparatus;

FIG. 11A is a block diagram showing an exemplary configuration of an imaging apparatus according to a fourth embodiment of the present invention that is applied to a scanner apparatus, and FIG. 11B is a block diagram showing an exemplary configuration of an imaging apparatus of the fourth embodiment that is applied to a copier apparatus;

FIG. 12 is a block diagram showing a configuration of an imaging system according to a fifth embodiment of the present invention; and

FIG. 13 is a block diagram showing a configuration of an imaging system according to a sixth embodiment of the present invention.

### DESCRIPTION OF THE PREFERRED EMBODIMENTS

Accordingly, embodiments of the present invention include an imaging apparatus and an imaging system in which the overall security state of the system as a whole may be easily determined and a user or a system administrator is able to grasp the operation of the respective security policies set within individual apparatuses.

Embodiments of the present invention also include a security management method and apparatus for enabling security management during an imaging operation so that the security level of a paper document subject to an imaging operation such as copying or scanning is maintained at the original security management level of this document.

Embodiments of the present invention further include an imaging apparatus and a security management apparatus that are capable of maintaining document security control even in a case where document information of a paper document being subjected to an imaging process cannot be read.

One or more of the above embodiments of the present invention includes an imaging apparatus that comprises:
a read unit configured to read image data from a physical document in response to an imaging request from a user;
a user information acquisition unit configured to acquire user information including a security attribute of the user;
a document information acquisition unit configured to acquire document information including a security attribute of the physical document;
an operating condition selection unit configured to determine whether to authorize outputting of the image data read from the physical document based on the user information and the document information by referring to a predetermined rule; and
a log management unit configured to store the image data in association with the user information without allowing the image data to be output when the document information is not acquired at the document information acquisition unit.

In an imaging apparatus according to an embodiment of the present invention, when document information for security determination is not acquired and the nature of a document cannot be confirmed, outputting of the read image data is withheld, and the image data are stored in the log management unit in association with the user information. When the document information is acquired, a determination is made as to whether the outputting of the image data may be authorized.

An embodiment of the present invention includes an imaging system that comprises:
an imaging unit configured to read image data from a physical document and conduct an imaging job for the physical document in response to an imaging request from a user;
a user profile management unit configured to acquire a user profile including a security attribute of the user;
a document profile management unit configured to acquire a document profile including a security attribute of the physical document;
an operation condition management unit configured to determine whether to authorize outputting of the image data read from the physical document based on the security attribute of the user and the security attribute of the physical document by referring to a rule table that describes a predetermined rule pertaining to imaging; and
a log management unit configured to receive the image data from the imaging unit and store the image data in association with the user profile when the document profile is not acquired at the document profile management unit;
wherein the imaging unit, the user profile management unit, the document profile management unit, the operating condition selection unit, and the log management unit are interconnected via a network; and
the imaging unit is configured to refrain from conducting the requested imaging job when the document profile is not acquired at the document profile management unit.

In an imaging system according to an embodiment of the present invention, functions pertaining to imaging and security management are divided into plural units to thereby reduce the processing load of each unit, and also, the document information including document security attributes and user information including user security attributes may be shared by the units within the system.

An embodiment of the present invention includes a security management apparatus that is connected to an imaging apparatus via a network, the apparatus comprising:
an operating condition selection unit including a rule table describing a rule pertaining to an imaging authorization standard based on a user security attribute and a document security attribute of a document under security management the operating condition selection unit being configured to refer to the rule table to determine whether to authorize execution of an imaging job for a physical document by the imaging apparatus when document information including a security attribute of the physical document is acquired;
an operations control unit configured to send an instruction to the imaging apparatus to prohibit the execution of the imaging job when the document information is not acquired; and
a log management unit configured to receive image data of the physical document from the imaging apparatus and store the image data in association with user information of a user of the imaging apparatus when the document information is not acquired.

In the following, preferred embodiments of the present invention are described with reference to the accompanying drawings.

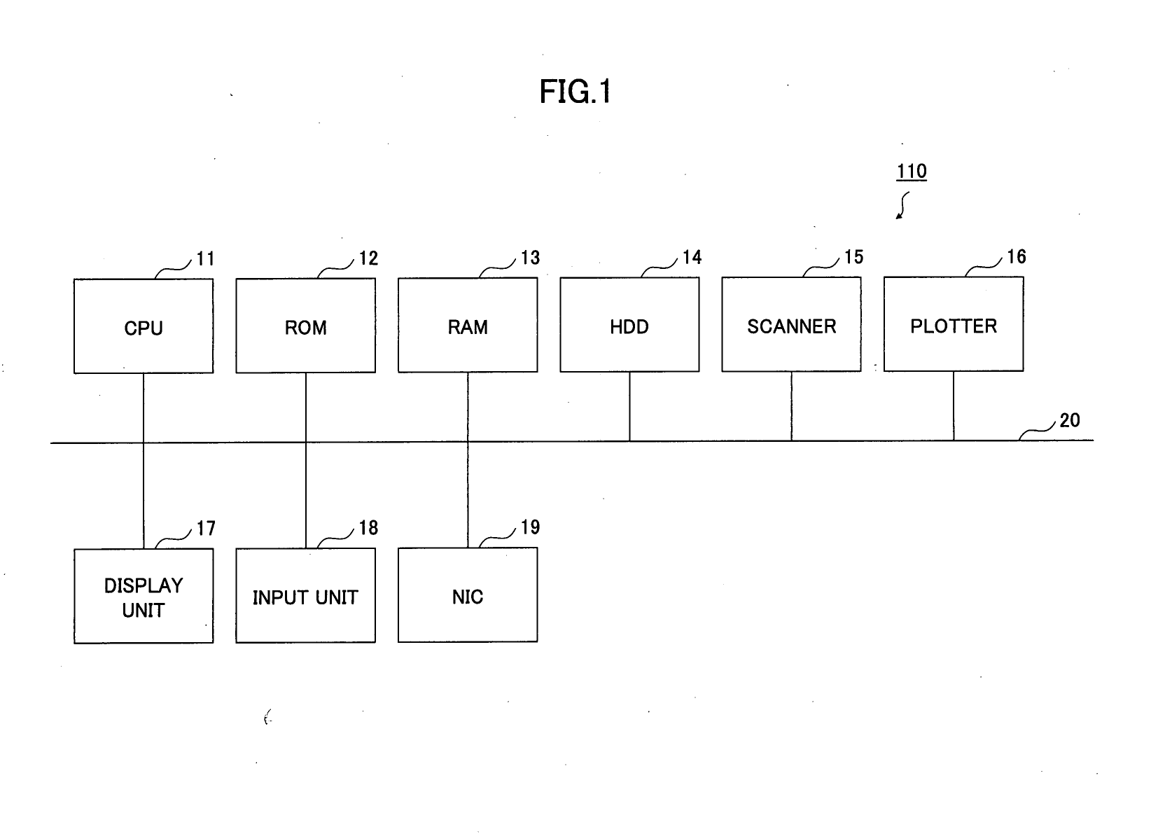

FIG. 1 is a diagram showing a hardware configuration of an imaging apparatus according to an embodiment of the present invention. The imaging apparatus 110 of the present embodiment includes a CPU (Central Processing Unit) 11, a ROM (Read-Only Memory) 12, a RAM (Random Access Memory) 13, a HDD (Hard Disk Drive) 14, a scanner 15, a plotter 16, a display unit 17, an input unit 18, and a NIC (Network Interface) 19. Also, in this example, the above components are interconnected by a bus 20.

In one embodiment, the CPU 11 is adapted to control the imaging apparatus 110 according to one or more control programs stored in the ROM 12. The CPU 11 is also adapted to control the operation of the imaging apparatus 110 according to one or more imaging programs that are stored in the HDD 14 and are loaded in the RAM 13 as is necessary or desired.

The HDD 14 may store imaging programs, document data files for printing that are transmitted via a network, and print processed image data, for example. The scanner 15 may be adapted to read a paper (physical) document through optical means to acquire image data therefrom, for example. The plotter 16 may be adapted to convert document data, which may be generated at a personal computer, for example, and transmitted to the imaging apparatus 110, into pixel data, and print the resulting data onto a predetermined medium such as paper, for example. The plotter 16 may also be adapted to conduct a process of reading and copying a paper document, for example.

The display unit 17 may include an operations panel for displaying pertinent information, for example. The input unit 18 may correspond to ten keys or a touch panel that is provided at the operations panel for inputting information according to an operation by the user, for example. The NIC 19 corresponds to an interface between the imaging apparatus 110 and a network, and may be adapted to transmit/receive electronic data (document data), image data and/or information pertaining to security to/from information apparatuses connected to the imaging apparatus 110 via the network for example.

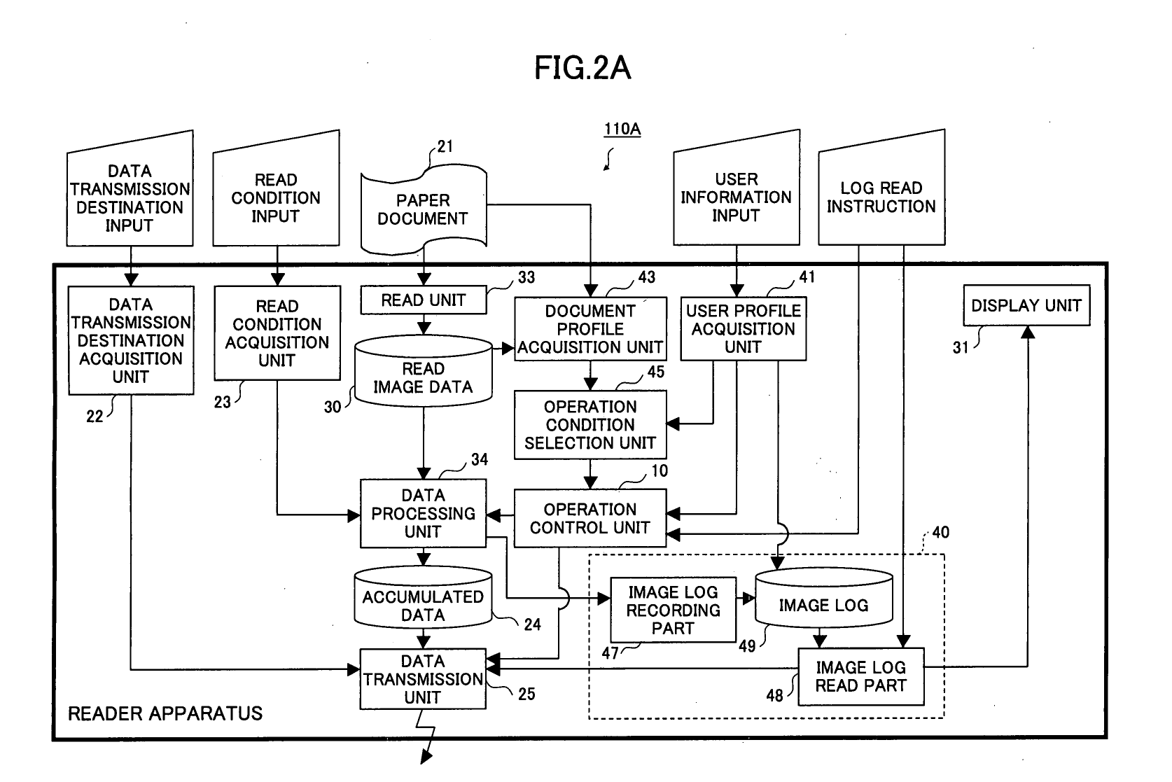

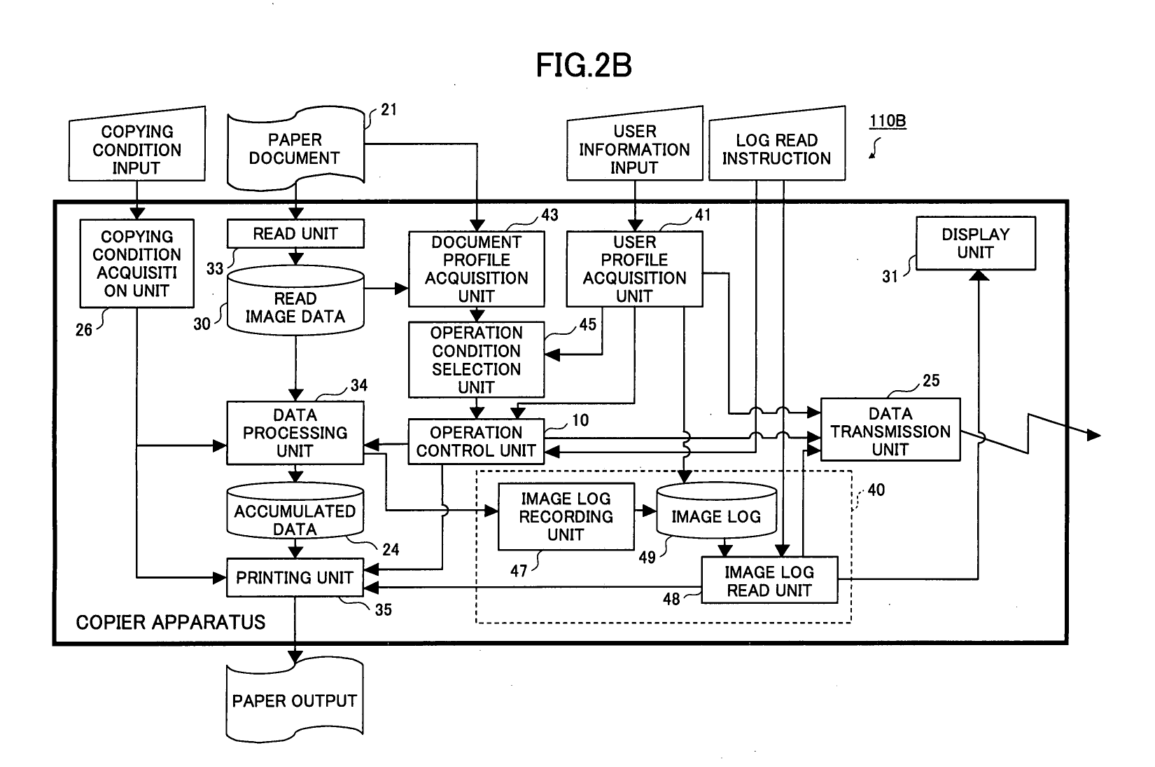

FIG. 2A is a block diagram showing a functional configuration of an imaging apparatus according to a first embodiment of the present invention that is applied to a scanner. The imaging apparatus 110A according to this embodiment includes a read unit 33 for scanning a paper document 21 according to a request from a user, a user profile acquisition unit 41 for acquiring a user profile that includes a security attribute of the user, a document profile acquisition unit 43 for acquiring a document profile including a security attribute of the paper document 21, an operating condition selection unit 45 for determining whether image data 30 of the paper document 21 may be output based on the user profile and the document profile by referring to a predetermined rule, and a log management unit 40 for storing image data 30 in association with the user profile.

The scanner 110A also includes a data transmission destination acquisition unit 22 for acquiring a transmission destination of electronic data of paper document 21, a read condition acquisition unit 23 for acquiring a read condition for document 21, and a display unit 31. The scanner Il OA further includes a data processing unit 34 for conducting halftone correction and/or gamma correction, for example, on the image data 30 according to the read condition set by the user. The processed image data may then be stored as accumulated data 24.

In one embodiment, the document profile of the paper document 21 maybe extracted from image data 30 generated by the scanner 110A; in an alternative embodiment, the document profile may be obtained from the paper document 21.

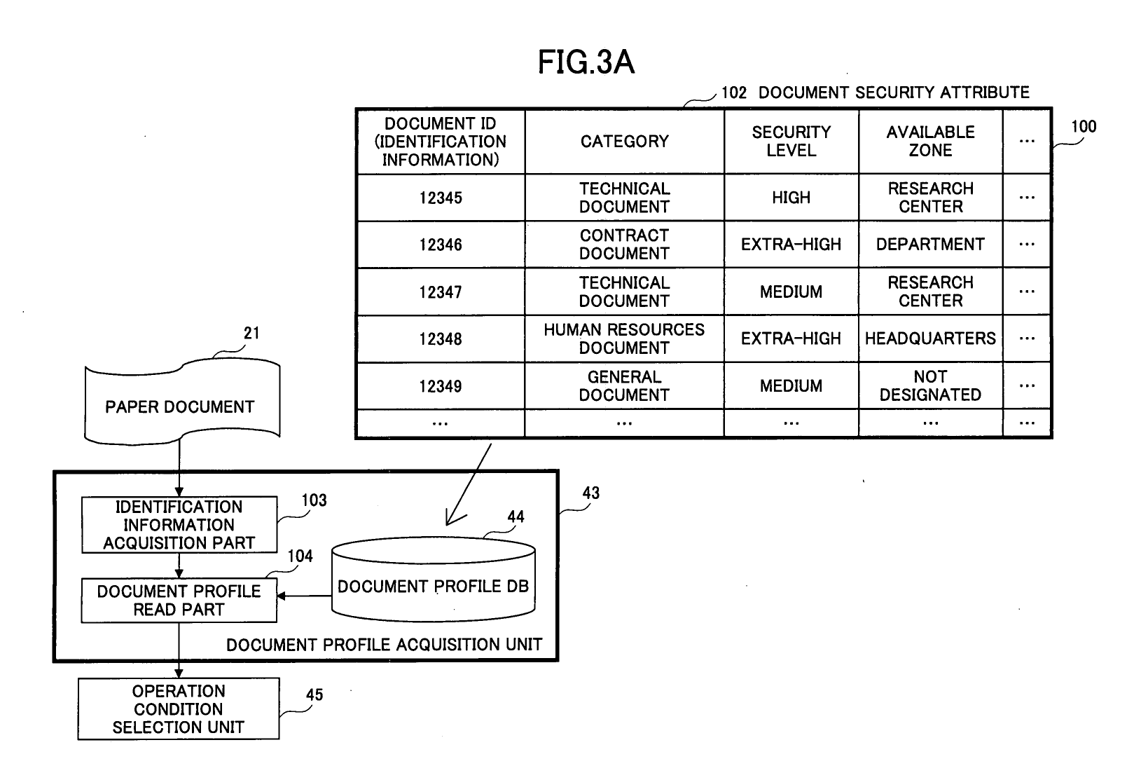

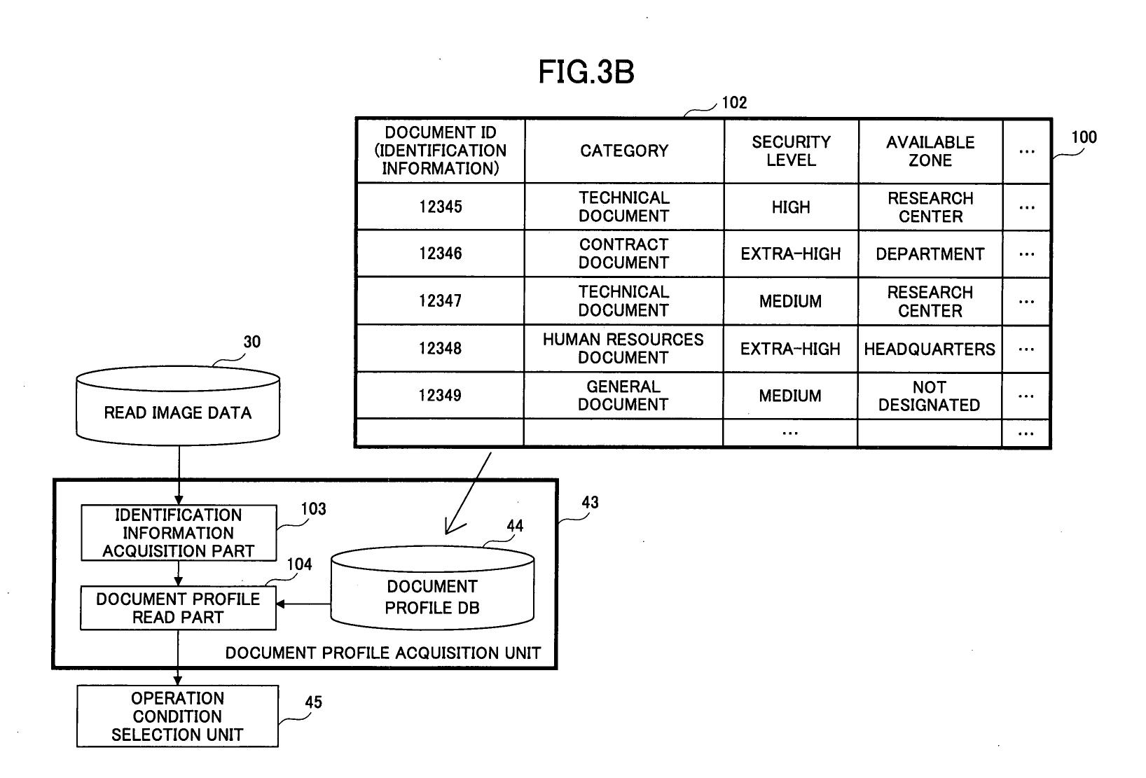

FIG. 3A is a diagram showing an exemplary configuration of the document profile acquisition unit 43 in the case where the document profile is acquired directly from the document 21 by rig identification information therefrom. In this example, the document profile acquisition unit 43 includes a document identification information acquisition unit 103 for reading a document ID that is assigned to the paper document 21, and a document profile read unit 104 for accessing a document profile database (DB) 44 and reading a corresponding document profile based on the read document ID. The read document profile may then be transmitted to the operating condition selection unit 45.

According to one embodiment, the document ID provided at the paper document 21 corresponds to identification information that does not include an image such as RFID (Radio Frequency Identification) or MCR (Magnetic Character Recognition). On the other hand, the document ID may correspond to identification information including an image such as a bar code, a QR code, or a character string, provided that a dedicated reader such as a barcode reader or an OCR (Optical Character Recognition) is implemented. In the present example, the document profile DB 44 includes a table 100 that stores document IDs in association with a document category, a security level, and an available zone. Each of the items describing a document category, a security level, and an available zone corresponds to a security attribute 102. In this example, the required security level of a document may be categorized as “EXTRA-HIGH”, “HIGH”, or “MEDIUM”, for example, according to the type of the document (category).

FIG. 3B is a diagram showing another exemplary configuration of the document profile acquisition unit 43 in a case where the document profile is acquired from the image data 30 generated by scanning the paper document 21. According to this arrangement, the document ID corresponds to ID information including image data such as a bar code, a QR code, a character, or a graphic pattern. It is noted that, aside from the fact that the document ID is extracted from the image data 30, the arrangement of the document profile acquisition unit 43 and the table 100 according to this example may generally be identical to that shown in FIG. 3A.

According to an embodiment, user information may be input via the input unit 18 (see FIG. 1) and a user profile may be acquired from the input information at the user profile acquisition unit 41.

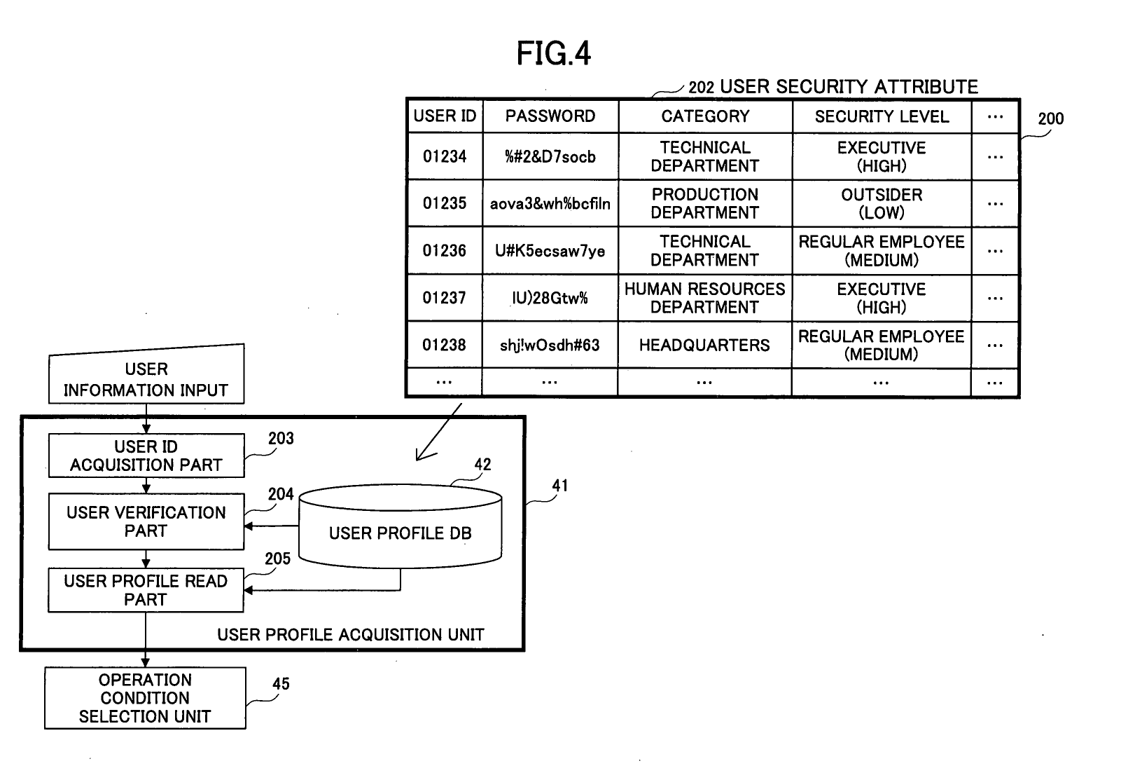

FIG. 4 is a diagram showing an exemplary configuration of the user profile acquisition unit 41. According to the present example, the user profile acquisition unit 41 includes a user ID acquisition unit 203 for acquiring user ID from the input information, a user verification unit 204 for conducting user verification, and a user profile reader unit 205 for reading a corresponding user profile from a user profile database DB 42 when a positive verification is made. The read user profile may then be supplied to the operating condition selection unit 45.

In the present example, the user profile DB 42 includes a table 200 that stores pre-registered user IDs in association with security attributes 202 such as a password, a category, and a security level. As is illustrated in the drawing, a security level for a user may be set to “ThGH”, “MEDIUM”, or “LOW”, for example, according to a rank or position of the user (category).

According to an embodiment, the operating condition selection unit 45 may include a rule table that describes rules pertaining to imaging with respect to the security level of a user and the security level of a document. For example, the rules of the rule table may include rules for determining whether image data may be output. The operating condition selection unit 45 may refer to the rule table to determine whether the image data 30 may be output based on a user profile transmitted from the user profile acquisition unit 41 and a document profile transmitted from the document profile acquisition unit 43.

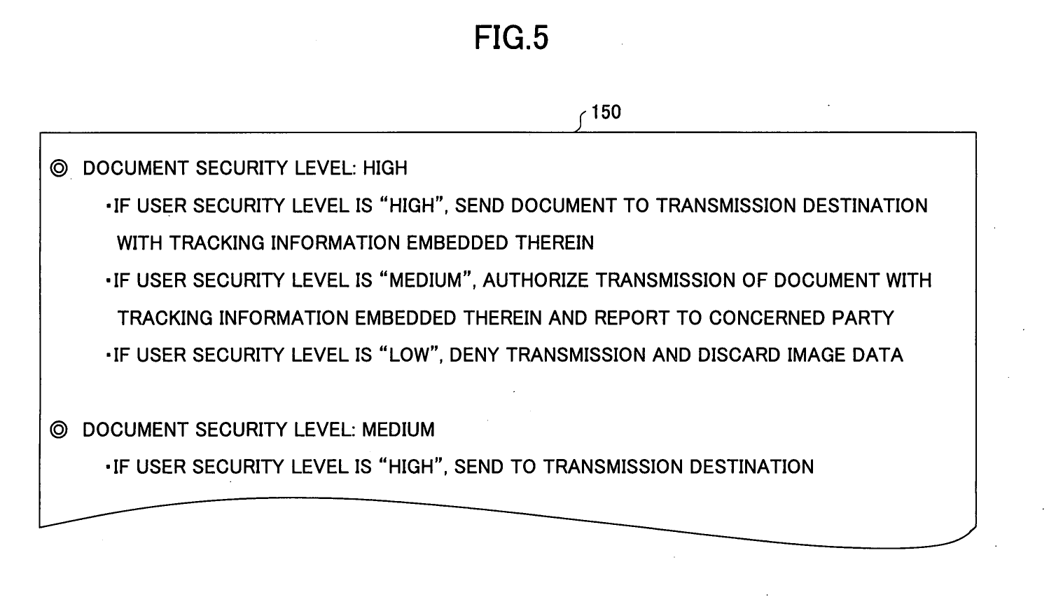

FIG. 5 illustrates an exemplary rule table 150 that may be stored in the operating condition selection unit 45. For example, in a case where the security level of a document being managed is set to “HIGH”, if the security level assigned to the user attempting to conduct an imaging operation on the present document is set to “HIGH”, outputting the corresponding image data may be authorized on condition that tracking information identifying the image data as “CLASSIFIED”, for example, is attached thereto. If the security level of the user is “MEDIUM-HIGH”, the outputting of the image data may be authorized with the tracking information attached thereto, and further, notification may be made of the authorization of the outputting to a concerned party. If the security level of the user is “MEDIUM” or “LOW”, the outputting may be denied and the image data may be discarded.

According to an embodiment, the rule table 150 may be easily rewritten or updated, and rules may be freely set with respect to each of the concerned imaging apparatuses.

Referring back to FIG. 2A, when the outputting of image data 30 is authorized based on rule table 150, an operations control unit 10 may administer a transfer unit 25 to transfer the accumulated data 24 to a designated data transmission destination.

On the other hand, when the outputting of the image data 30 is not authorized, the accumulated data 24 may be immediately discarded.

Also, it is noted that there may be a case in which a document profile may not be acquired from the paper document 21. For example, such a case may occur due to the following reasons. First, the paper document 21 may not have been registered as a document under security management in the fist place so that it does not have a document ID assigned thereto. Second, the paper document 21 may correspond to a document under security management with a document ID assigned thereto, but the document ID may be in an unreadable state due to staining of the paper document 21, for example. Third, the paper document 21 may correspond to a document under security management, but its document ID may be intentionally hidden or tampered with in order to conduct illegal scanning, for example.

In such a case, security evaluation cannot be conducted, and in turn, the operations control unit 10 may store the accumulated data 24 in the log management unit 40 in association with the user information of the user that has conducted the scanning operation instead of outputting the accumulated data 24. It is noted that the operations control unit 10 may be arranged to administer the log management unit 40 to store the image data as well as to administer the data transmission unit 25 to transmit a message to the system administrator and/or other concerned parties indicating that the document profile could not be acquired. Additionally, this message may be indicated by the display unit 31 to notify the user of such situation.

In the present example, the log management unit 40 includes an image log recording unit 47 for receiving processed image data, an image log DB 49 for storing the image data in association with a user profile, and an image log read unit 48 for receiving a request to access the image data being stored.

According to an embodiment, when an access request for stored image data is received, the image log read unit 48 determines whether the concerned stored image data may be output based on the security level of the concerned image data (document) and the security level of the user making the access request according to the rules defined in the rule table 150. For example, if the security level of the stored image data is set to “HIGH” or “MEDIUM”, and the security level of the user making the access request is set to “HIGH”, the data transmission unit 25 may be administered to transmit the concerned image data. In such a case, a message may be sent to a concerned party at the same time indicating that data outputting has been conducted according to an access request. On the other hand, in a case where the security level of the concerned image data is set to “MEDIUM” and the security level of the user making the access request is set to “MEDIUM”, access may be denied. It is noted that after the stored image data are output according to an access request, the concerned image data may be deleted.

As is described above, the rules for determining accessibility of a document may be freely defined, and thereby the rules may be suitably set according to the environment in which the scanner 110A is implemented, for example.

Upon authorizing the reading of stored image data, the log management unit 40 is preferably arranged to check whether tampering with the concerned image data appears to have taken place. In the present example, a hash value based on a hash function is calculated for image data stored in the image log DB 49 by the image log recording unit 47, and the concerned image data are stored in a predetermined address according to the calculated hash value. Thus, upon receiving an access (read) request, the image log read unit 48 may check to see whether any data tampering has been conducted on the concerned image data by comparing the hash value calculated by the image log 40 and the hash value at the time of recording. When it is determined that the image data have been tampered with based on the above comparison, a message signaling the detection of data tampering may be output along with the stored image data.

It is noted that, in one embodiment, the rule table 150 may be arranged to define processing rules for a case in which a document profile is acquired and the security level of the paper document 21 is recognized but a user profile cannot be acquired from the input user information. In such a case, outputting of the image data may be prohibited according to the security level of the paper document 21, the image data may be stored in the log management unit 40, and notification may be made of the fact that a user profile could not be obtained. Alternatively, the outputting of the image data may be allowed, and notification may be made of the fact that a user profile could not be obtained.

FIG. 2B shows a functional configuration of an imaging apparatus according to the first embodiment that is applied to a copier. It is noted that the basic configuration and functions of the copier 110B of the present example are identical to those of the scanner 10A shown in FIG. 2A aside from the fact that the present copier 110B includes a printing unit 35 as means for outputting the processed image data.

According to the present example, upon obtaining the document profile and the user profile, the operating condition selection unit 45 may refer to the rule table 150 (FIG. 5) and determine whether the read image data may be output. In a case where the outputting is authorized, the printing unit 35 may generate a toner image on a predetermined recording medium according to an instruction from the operations control unit 10 to output a hard copy of the image data In a case where the outputting of the image data is denied or prohibited, the image data may be discarded according to an instruction from the operations control unit 10.

In a case where a document profile cannot be obtained from the paper document 21, the image data may not be copied or reproduced on the recording medium, and the image data may instead be stored in the log management unit 40. In such a case, a message signaling that the document profile has not been obtained may be transmitted to the system administrator and/or other concerned parties via the data transmission unit 25.

It is noted that the operations conducted in a case where an access request is made for image data stored in the image log DB 49 may be identical to those conducted in the scanner 110A.

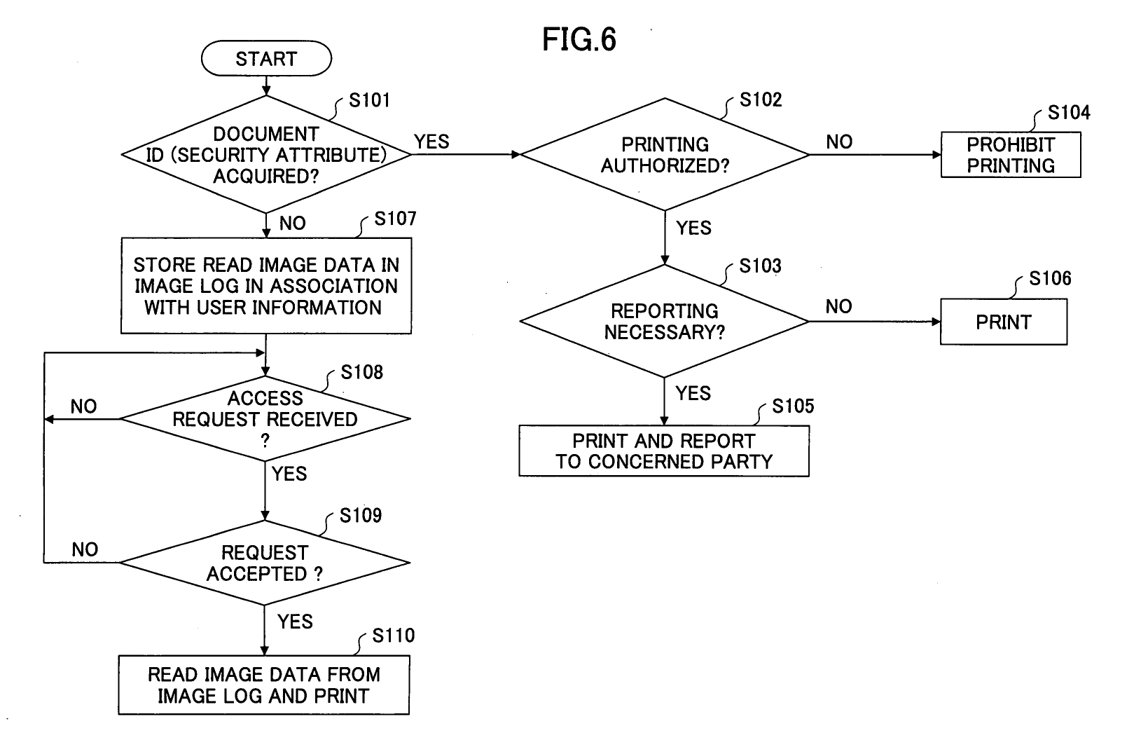

FIG. 6 is a flowchart illustrating an operational flow of the copier 110B.

According to FIG. 6, first, when a copying job for the paper document 21 is executed, a determination is made as to whether a document ID (or security attributes of the document) has been acquired from the paper document 21 (S101). In a case where a document ID is acquired (S101, YES), the rule table is referenced and a determination is made as to whether execution of the copying job should be authorized based on the security attributes of the document and user information of the user executing the copying job (S102). In a case where the copying job is prohibited (S102, NO), the image data are discarded without being printed (S104).

In a case where the copying job is authorized (S102, YES), a determination is made as to whether notification or reporting of the execution of the present copying job needs to be conducted (S103). In a case where the rule table indicates that such notification or reporting is necessary (S103, YES), the image data are printed, and at the same time, the execution of the printing job is reported to a concerned party (S105). In a case where such notification or reporting is not required (S103, NO), the image data are printed out on a predetermined sheet or some other recording medium (physical document) (S106). It is noted that step S103 is not a required step and may optionally be skipped.

In a case where the document ID is not acquired (S101, NO), the read image data are stored in the image log in association with user information (S107). When there is an access (read) request for the stored image data (S108), a determination is made as to whether such reading may be authorized based on the user information of the user that is making the access (read) request (S109). When the request is authorized (S109, YES), the stored image data are read from the image log DB 49 and copied onto a sheet of paper or some other recording medium (S110). In this case, a message signaling that the image data have been read from the image log 49 may be output along with user information of the user that has gained access to the image data.

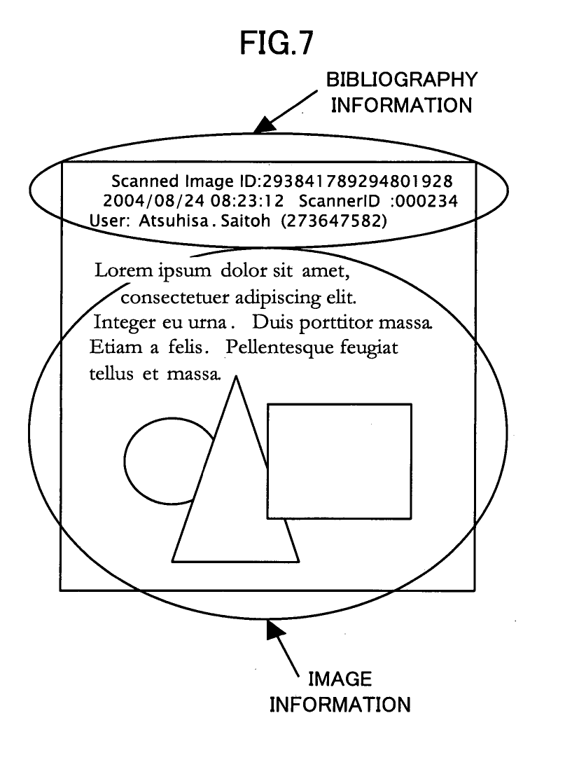

FIG. 7 shows an example of an output image that is read from the image log 49. In the example of FIG. 7, a scanned image ID number, the date and time of the reading, and user information, for example, are printed along with the read image.

Outputting of the image log may take the form of transmission of an electronic file in the case of the scanner 10A and outputting onto paper in the case of the copier 110B. In possible future applications in which multifunction imaging apparatuses may be equipped with high definition displays, the outputting may also take the form of an image display on the high definition display.

As is described above, according to the first embodiment of the present invention, rules may be easily set and changed for each individual apparatus, and management and comprehension of the set security state may be facilitated. Image outputting may be conducted when security control standards are satisfied. On the other hand, when the security condition standards are not satisfied, the image outputting is not conducted so that a user is able to recognize the security state of a paper document at the time of executing an imaging operation.

Further, in a case where the document ID or the document profile of a paper document cannot be acquired, the corresponding image data may be stored in the image log instead of being copied or transmitted so that security may be controlled even for documents of which security control standards are unidentified.

The above-described scanning and copying operations may also be realized by a software program, for example. In such a case, an imaging program may be installed in the scanner or copier apparatus so that process operations as described below may be executed:
(a) generating image data of a paper document that is read in response to an imaging request from a user
(b) acquiring document information including security attributes of this paper document
(c) acquiring user information including security attributes of the user
(d) determining whether to authorize outputting of the image data of the paper document based on the user information and document information by referring to a predetermined rule
(e) storing the image data in association with the user information without outputting the requested image data when the document information of the paper document is not acquired.

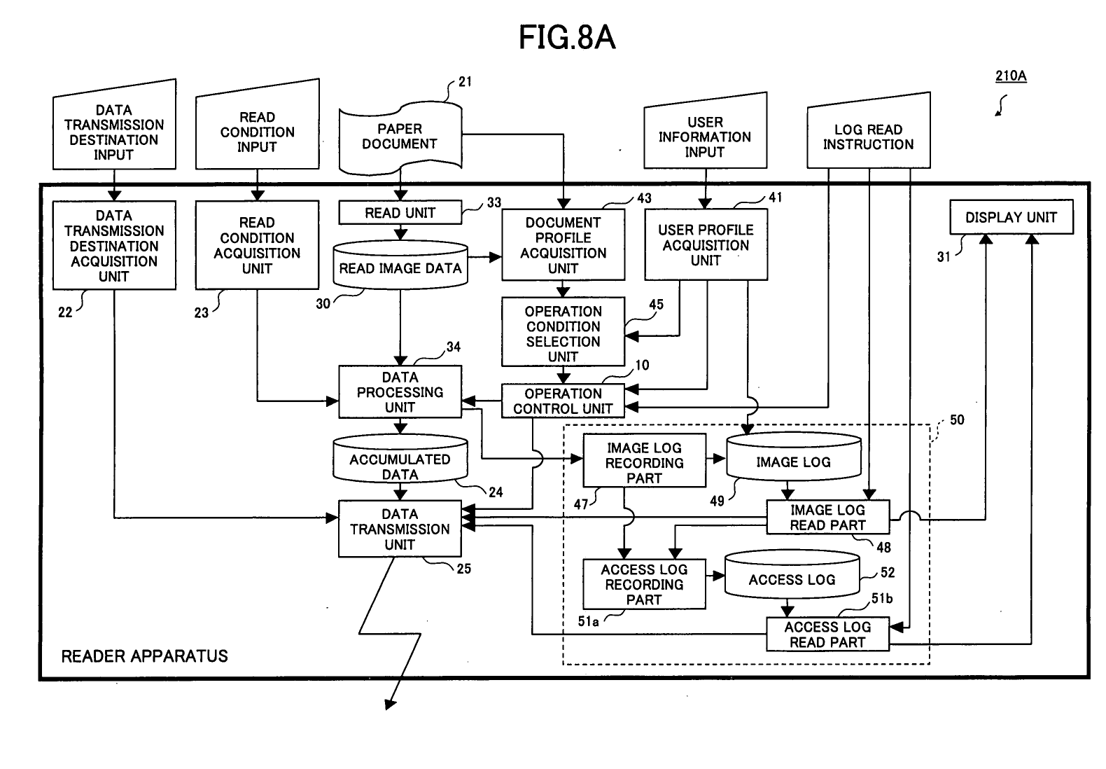

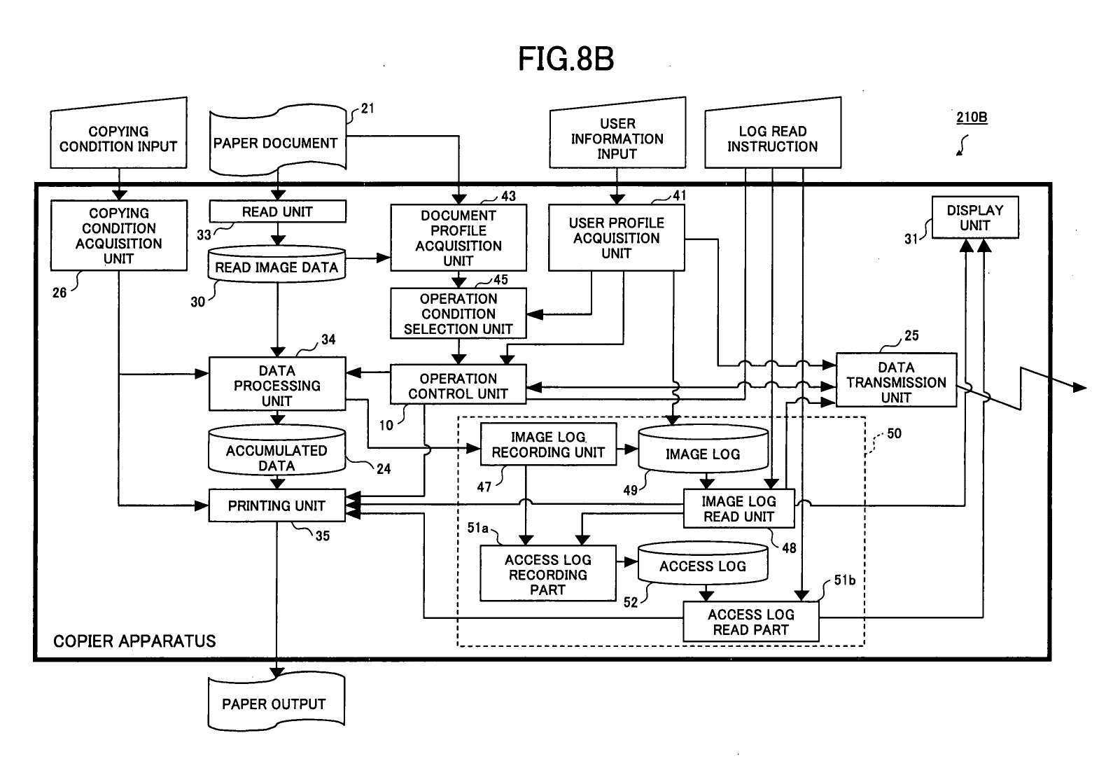

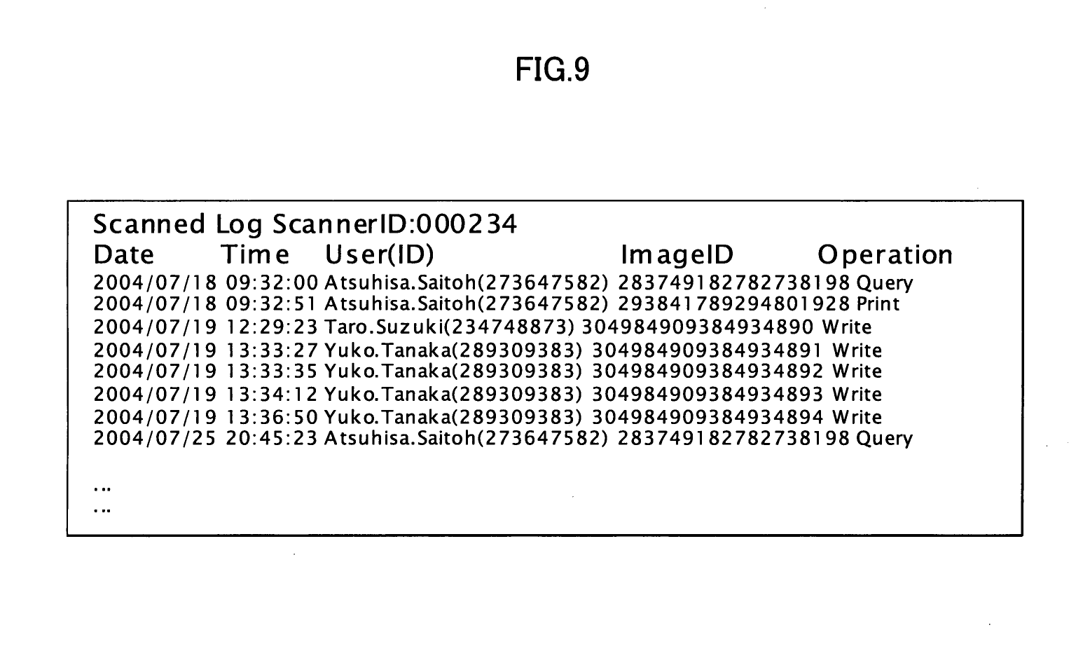

In the following, a second embodiment of the present invention is described with reference to FIGS. 8 and 9.

FIG. 8A shows an exemplary case in which the imaging apparatus according to the second embodiment is applied to a scanner. FIG. 8B shows an exemplary case in which the imaging apparatus according to the second embodiment is applied to a copier.

The second embodiment implements a log management unit that is different from that of the first embodiment. Specifically, a log management unit 50 implemented in a scanner 210A and a copier 220B according to the second embodiment includes an access log recording unit 51a, an access log read unit 51b, and an access log DB 52 in addition to an image log recording unit 47, an image log read unit 48, and an image log DB 49 that are also implemented in the first embodiment.

In one embodiment, each time the image log read unit 48 receives an access request, the access log recording unit 51a may be adapted to record the access request in association with user information of the user making the request in the access log DB 52. Also, information as to whether the reading has been authorized may also be recorded in association with the access request.

The recorded access log may be output in response to a log read request. According to the first embodiment, a message in the form of e-mail, for example, may be transmitted to a system administrator or some other concerned party reporting a case in which an access request is denied and even a case in which the access request is accepted depending on the document security attribute and the user security attribute. According to the second attribute, by storing received access requests in the access log DB 52, the system administrator may be able to survey the individuals making attempts to copy or scan-transfer paper documents and the respective results of whether outputting of image data is authorized or denied.

FIG. 9 shows an example of an output access log. As with the image log, the access log may be transmitted as an electronic file, for example, in the case of the scanner 210A, and the access log may be output onto paper, for example, in the case of the copier 210B. Also, since the access log, unlike the image log, may take the form of a list of characters, it may be displayed on the display unit 31, for example.

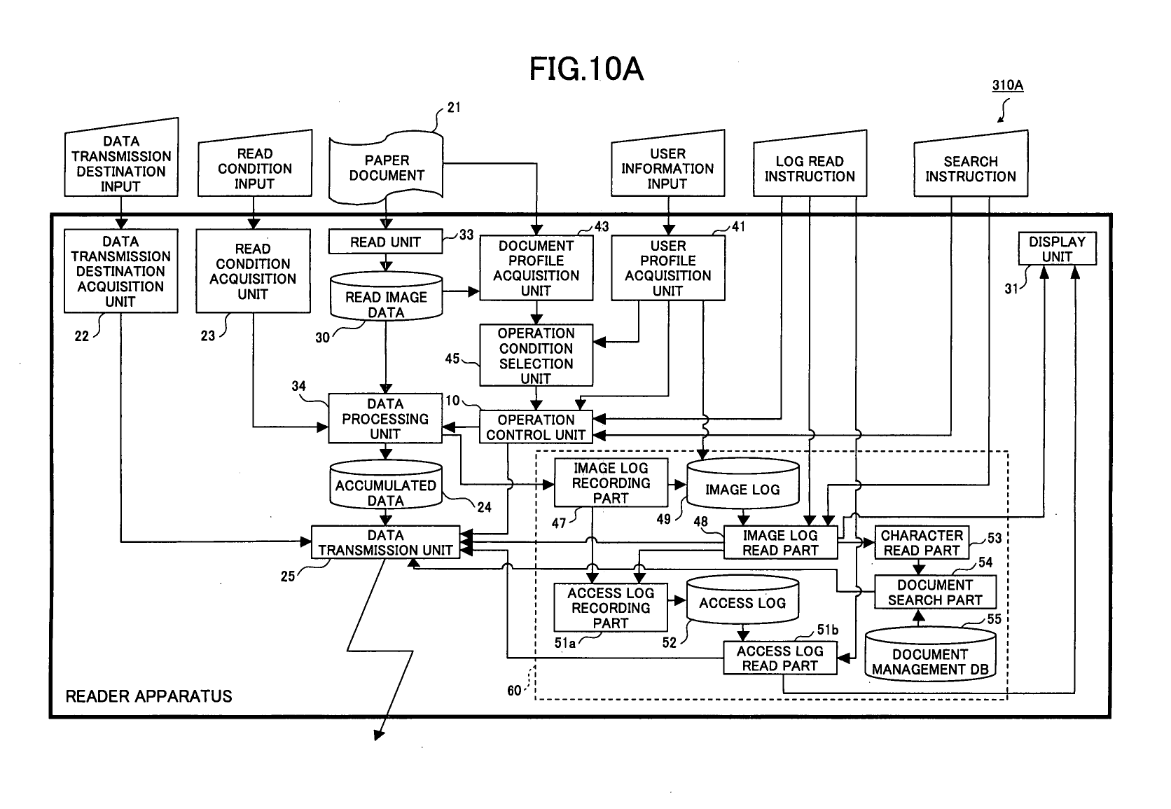

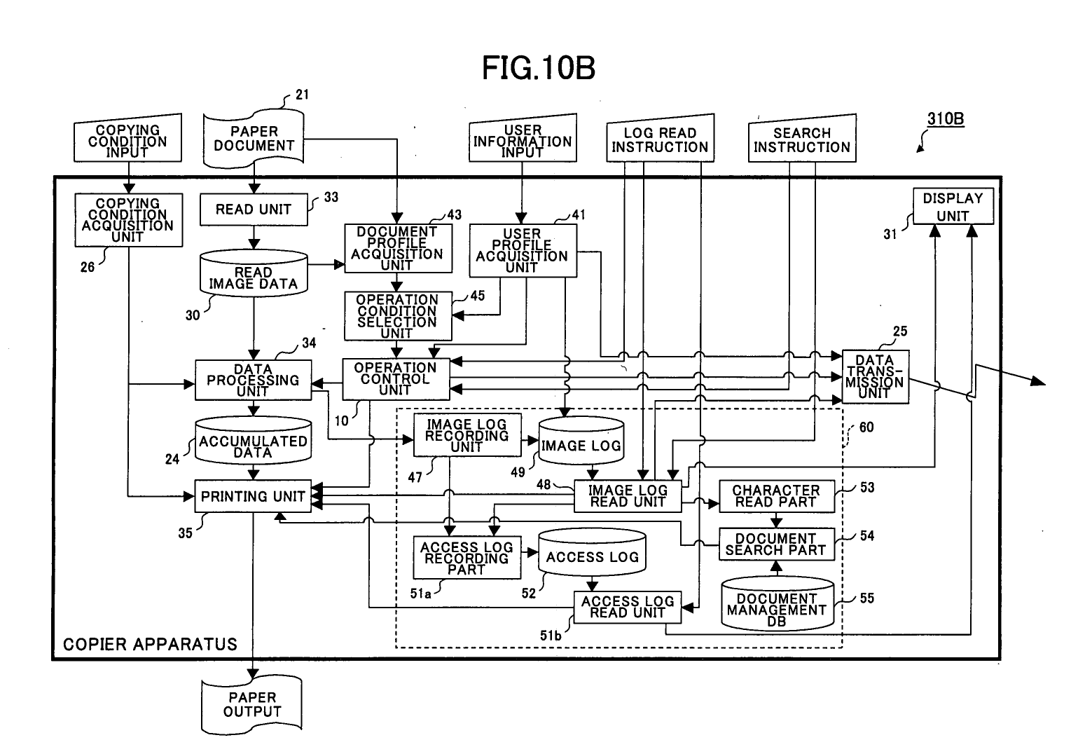

FIGS. 10A and 110B are block diagrams illustrating imaging apparatuses according to a third embodiment of the present invention. FIG. 10A shows an example of a case in which the imaging apparatus of the third embodiment is applied to a scanner 310A, and FIG. 10B shows a case in which the imaging apparatus of the third embodiment is applied to a copier 3101B.

According to the third embodiment, when a document profile of a paper document cannot be acquired, a determination may be made as to whether the paper document corresponds to a document under security management. A log management unit 60 that is implemented in the present embodiment includes a character read unit 53 and a document search unit 54 in addition to the features of the log management unit 50 of the second embodiment. In one embodiment, the character read unit 53 may extract image data of a predetermined unit of the paper document such as the title or a certain line from the stored image data, conduct character recognition thereon, and convert the extracted data into a character string. The document search unit 54 may refer to an internal or external (with respect the imaging apparatus, i.e., the scanner 310A or copier 310B) document management database 55 to search for a document that includes the converted character string within the document management database 55.

When a document including the converted character string is found in the document management database 55, the paper document may be presumed to correspond to a document under security management. Such a case signifies that the document ID of the read document could not be identified despite the fact that such document ID is assigned to the paper document. Although this may be caused by many factors such as staining of the paper document or a decrease in sensitivity of the read unit 33, there is also a high probability that the document ID has been intentionally hidden or tampered with to conduct illegal copying or scanning of the paper document.

Accordingly, in one embodiment, when matching document data with respect to the extracted character string are detected in the document management database 55, a message may be sent to the system administrator signaling that the document ID of a document under security management could not be identified. Alternatively, depending on the user security attribute, the stored image data may be output while notifying the system administrator that the document ID could not be identified at the same time.

On the other hand, in a case where a match for the extracted character string cannot be found, it is likely that the paper document does not correspond to a document held under security management in the first place. In such a case, a message is sent to the system administrator reporting that a match for the extracted character string could not be found in the document management database 55, and the stored image data may be output. After the outputting, the image data may be deleted from the image log 47.

The process step to be conducted depending on whether a match for the character string is found may be suitably arranged in the rule table 150 according to various conditions such as the environment in which the imaging apparatus is situated.

It is noted that in the examples of FIGS. 10A and 10B, the document management database 55 is provided within the imaging apparatus; however, the document management database 55 may also be provided outside the imaging apparatus. In such a case, the document search unit 54 may be adapted to search for a corresponding match of the character string via an interface (not shown).

It is noted that in one embodiment, a search for the character string may be automatically started when image data are stored in the image log 49 due to an inability to acquire a corresponding document profile thereof. Alternatively, the search may be initiated based on a search instruction from a user or a system administrator. For example, when a document profile cannot be acquired, this effect may be indicated on the display unit 31. Accordingly, a user or a system administrator may input a search instruction through the input unit 18 (FIG. 1). While a match for the character string is being searched for, the extracted and converted character string may be displayed on the display unit 31. When a match for the converted character string is detected, the section of the document containing the detected matching character string may also be displayed on the display unit 31. The user or system administrator may thus verify whether the character strings actually correspond, and further investigate the cause for not being able to acquire the document profile.

In one embodiment, the document search unit 62 may be adapted to record a search log containing an outcome of a search, i.e., whether a matching character string has been detected, and an outcome of the imaging operation, i.e., whether the image data are output, in association with a user ID of the user conducting the imaging operation.

In the imaging apparatus according to the third embodiment, even when a document ID is not acquired from a paper document, document security control may be maintained during an imaging operation. Also, even in an environment in which documents under security management and general documents (e.g., magazine articles, books, etc.) are equally handled and processed, security of a confidential document may be guaranteed without obstructing an imaging operation.

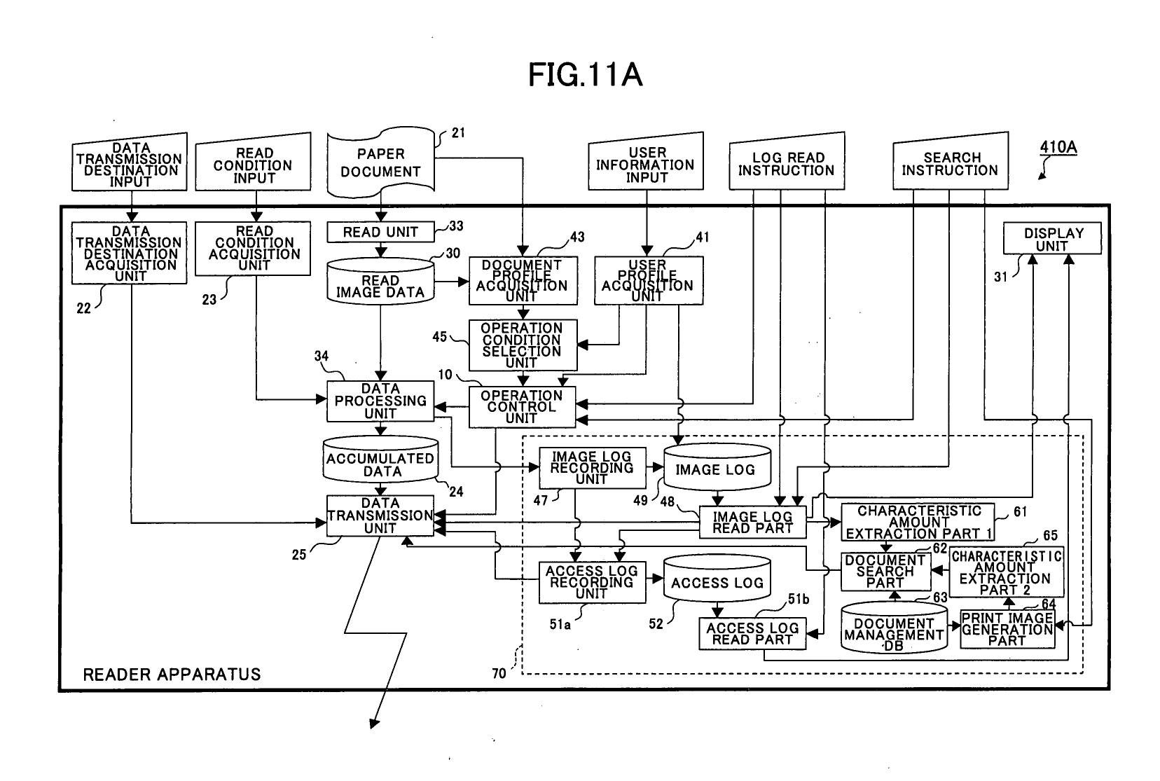

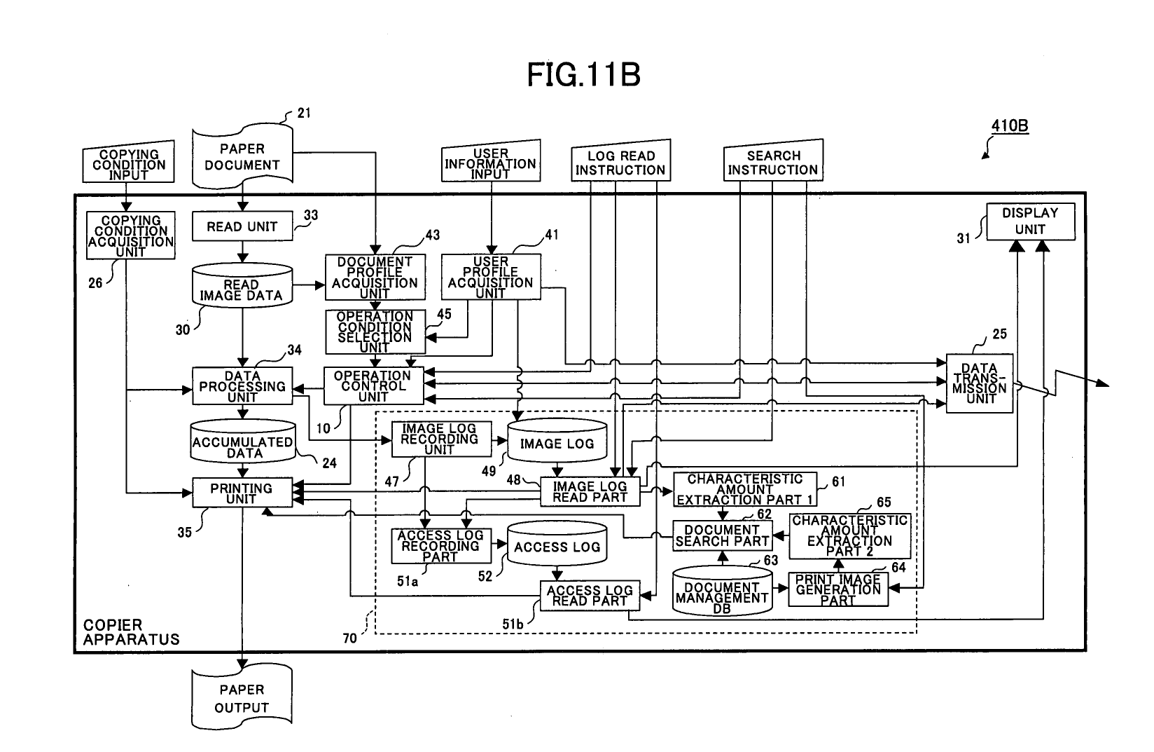

FIGS. 11A and 11B are block diagrams illustrating exemplary configurations of an imaging apparatus according to a fourth embodiment of the present invention. FIG. 11A shows a case in which the imaging apparatus of the present invention is applied to a scanner 410A, and FIG. 11B shows a case in which the imaging apparatus of the present invention is applied to a copier 410B.

In the fourth embodiment, a determination is made as to whether a paper document corresponds to a document held under security management as in the third embodiment. However, the manner in which the determination is conducted according to the present embodiment differs from that of third embodiment. That is, in the present embodiment, a characteristic amount of image data that is subject to processing is used to conduct a comparison rather than extracting a character string. A characteristic amount of image data may correspond to a shading distribution or a spatial frequency distribution, for example.

A log management unit 70 of the present embodiment includes a first characteristic amount extraction unit 61 for extracting a characteristic amount of image data stored in the image log DB 49 and a document search unit 62 for referring to a document management DB 63 that is provided within or outside of the imaging apparatus and searching to see whether a document having the image data characteristic corresponding to the extracted characteristic amount is included in the document management DB 63. Also, the log management unit 70 of the present invention includes a print image generating unit for converting document data stored in the document management database 63 into image data, and a second characteristic amount extracting unit 65 for extracting a characteristic amount from the converted image data. Accordingly, the document search unit 62 may be adapted to compare the characteristic amount of image data extracted by the first characteristic amount extraction unit 61 and the characteristic amount of the document stored in the document management database 63 extracted by the second characteristic amount extraction unit 65, and determine whether there is a matching document in the document management database 63 with a characteristic identical to the extracted characteristic amount of the image data stored in the image log DB 49.

In a case where a matching characteristic amount is detected, that is, when a document with a shading distribution or a spatial frequency distribution that is substantially identical to that of the image data of the paper document is found in the document management database 63, it may be presumed that a document ID of the paper document was not identified or acquired despite the fact that the paper document corresponds to a document held under security management. Accordingly, outputting of the image data of the paper document may be prohibited and a message may be sent to the system administrator signaling that a document ID of the paper document corresponding to a document held under security management could not be acquired, for example. Alternatively, depending on the rules being set, the read and stored image data may be output while notifying the system administrator of the fact that a document ID of the paper document corresponding to a document under security management could not be acquired, for example.

In a case where a matching characteristic amount cannot be found, it is likely that the paper document corresponds to a general document that is not held under security management. In such a case, the corresponding image data may be output while a message signaling that no matching characteristic amount has been detected is sent to the system administrator.

It is noted that the document search process according to the fourth embodiment may be limited in its accuracy compared to the third embodiment; however the processing time may be reduced in this embodiment.

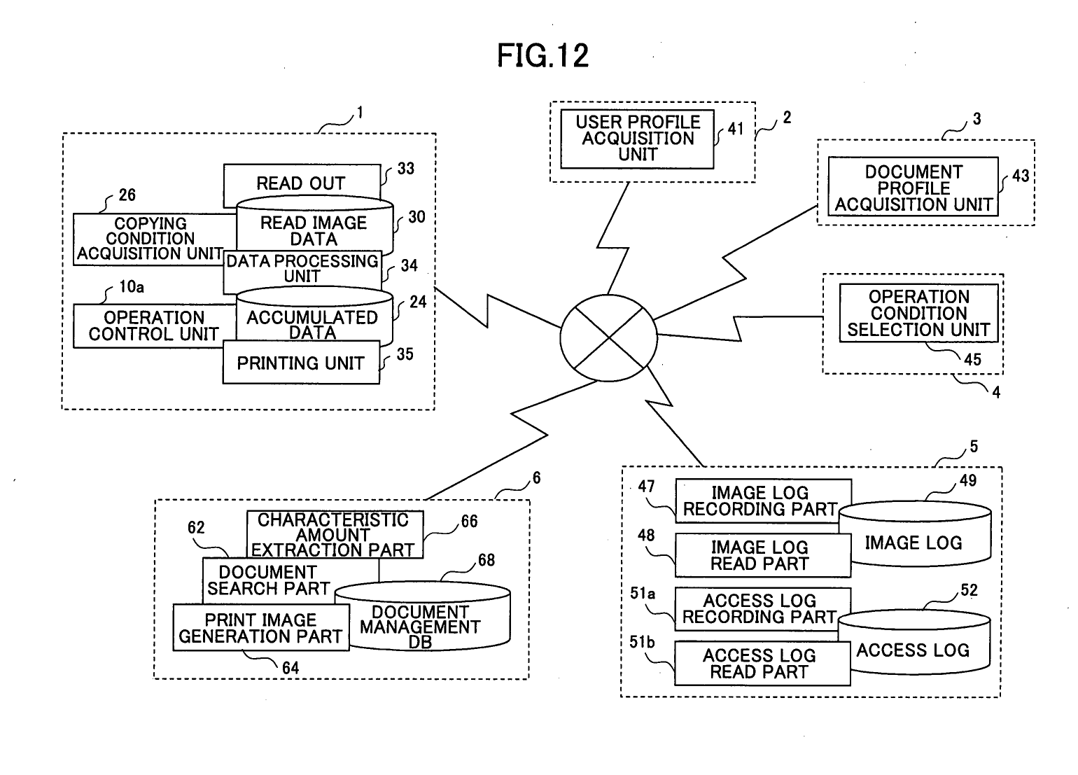

FIG. 12 shows an exemplary configuration of an imaging system according to a fifth embodiment of the present invention. The imaging system of the present example includes an imaging module 1, a user profile management module 2, a document profile management module 3, an operation condition management module 4, a log management module 5, and a document management module 6 that are interconnected via a network.

In one embodiment, the imaging module 1 may correspond to a copier, for example, that includes a read unit 33 for reading and generating image data 30 from a paper document in response to a user request, a data processing unit 34 for generating accumulated data 24 by conducting predetermined image processing on the image data, a copying condition acquisition unit 26, and an operations control unit 10A for controlling the imaging operation. The user profile management module 2 includes a user profile acquisition unit 41, and may be adapted to acquire and manage a user profile of a user who is using the imaging module 1. The document profile management module 3 includes a document profile acquisition unit 43, and may be adapted to acquire and manage a document profile of a paper document that is handled at the imaging module 1, for example. The operation condition management module 4 includes an operating condition selection unit 45, and may be adapted to refer to a rule table (FIG. 5) that describes predetermined rules pertaining to image processing to thereby determine whether outputting of the image data of the paper document read by the imaging module 1 may be authorized. Also, in the example of FIG. 12, the log management module 5 is arranged to have a configuration corresponding to that of the log management unit 50 of the second embodiment.

In one embodiment, when a document profile is not acquired at the document profile management module 3, the log management unit 5 may receive image data from the imaging module 1 and store the received image data in association with the user profile of the current user in the image log DB47.

In the case where a document profile is not acquired, the imaging module 1 may refrain from executing a requested imaging job of outputting image data until such image outputting is authorized.

When an access request for image data stored in the image log DB 47 is issued, the log management module 5 may determine whether access may be authorized based on user security attributes of the user making the access request. When access is authorized, the stored image data may be transmitted to the imaging unit 1 via the network.

It is noted that access requests received at the log management module 5 may be stored in the access log DB 52 in association with their corresponding user profiles.

The document management module 6 may optionally be connected to the network. In the example of FIG. 12, the document management module 6 includes a characteristic amount extraction unit 66, a document search unit 62, a document management database 68, and a print image generating unit 64. When a document profile is not acquired at the document profile management module 3, the document search unit 62 may conduct a search to see whether a document with a characteristic amount that is substantially identical to the characteristic amount of image data of the paper document read at the imaging module 1 exists within the document management database 68.

The operating condition management module 4 of the present example maybe arranged to determine whether outputting of the image data stored in the log management module 5 may be authorized based on the search result, and notify the imaging module 1 of the determination result.

According to the fifth embodiment of the present invention, the functions of each of the imaging apparatuses according the first through fourth embodiments of the present invention are distributed so as to reduce the processing load and to thereby increase the processing speed. It is noted that effects of maintaining security control realized in the present embodiment may be substantially identical to those realized by the first through fourth embodiments of the present invention.

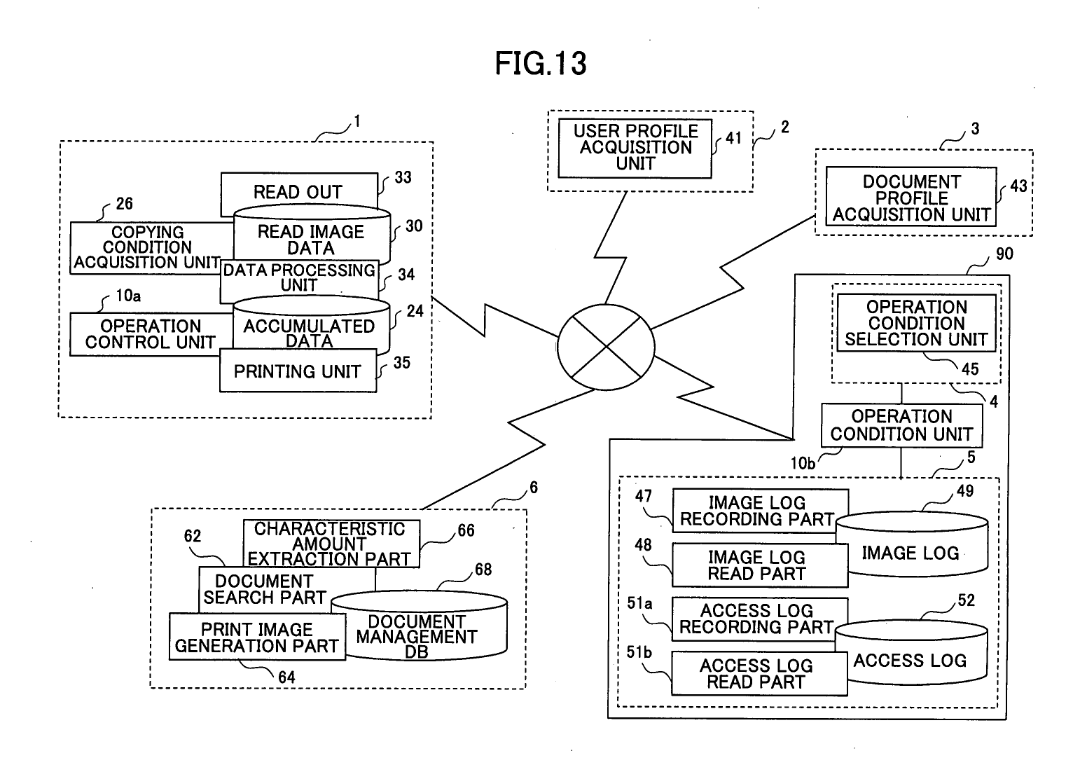

FIG. 13 illustrates configuration of an imaging system including a security management apparatus 90 according to a sixth embodiment of the present invention. According to the present example, the security management apparatus 90 is connected to an imaging module 1, a user profile management module 2, a document profile management module 3, and a document management module 6 via a network.

In this embodiment, the security management apparatus 90 includes an operating condition selection unit 4, an operations control unit 10b, and a log management unit 5. The operating condition selection unit 4 includes the rule table 150 (FIG. 5) describing rules pertaining to imaging that uses user security attributes and document security attributes of documents under security management as standards. When the document profile management unit 3 acquires a document profile of the paper document handled by the imaging module 1, the security management apparatus 90 of the present embodiment may determine whether to authorize transmission or printing of image data of the paper document read by the imaging module 1 by referring to the rule table 150.

The operations control unit 10b of the present embodiment may be arranged to prohibit printing of the image data by the imaging module 1 or transmission of the image data to other apparatuses outside the security management apparatus 90 in a case where the document profile is not acquired. The log management unit 5 may be arranged to receive image data from the imaging module 1 and store the received image data in the image log recording unit 47 in association with the user profile of the user of the imaging module 1 in a case where the document profile is not acquired.

When an access request for the stored image data is received, the log management unit 5 may determine whether to authorize reading of the image data based on the security attributes of the user making the access request. In the case of authorizing reading of the image data, the operations control unit 10b may output a transmission instruction to send the stored image data to the imaging module 1.

Also, when an access request for the stored image data is received, the log management unit 5 may be arranged to store the access request in the access log DB 52 in association with the user information of the user making the request.

By implementing the security management apparatus 90 of the present embodiment, document security control may be maintained even in a case where a document profile of a paper document subject to a copying or scanning operation is not acquired.

It is noted that the operation of the security management apparatus ⁹⁰ may also be executed by a software program. In such a case, a security management program may be installed in the security management apparatus 90 to realize execution of the process operations described below:
(a) acquiring document information including security attributes of a paper document that is subject to imaging by an imaging apparatus, the image data of the paper document being read in response to a user imaging request
(b) acquiring user information including security attributes of the user
(c) determining whether to authorize outputting of the image data of the paper document based on the user information and document information by referring to a predetermined rule pertaining to imaging that is defined beforehand
(d) prohibiting the requested imaging operation, receiving the image data from the imaging apparatus, and storing the received image data in association with the user information when the document information of the paper document is not acquired.

It is noted that although in the examples illustrated in FIGS. 12 and 13, one single imaging module 1 is connected to the network, plural imaging modules 1 may be connected to the network, and the user profile management module 2, the document profile management module 3, the security management apparatus 90, and the document management unit 6 may be shared by the plural imaging modules 1 of the imaging system. In such a case, the rule table 150 of the operating condition selection unit 45 may include rules for each of the imaging modules 1 so that security of plural imaging jobs may be collectively managed.

Further, the present invention is not limited to the embodiments described above, and variations and modifications may be made without departing from the scope of the present invention.

The present application is based on and claims the benefit of the earlier filing date of Japanese Patent Application No.2003-385462 filed on Nov. 14, 2003, and Japanese Patent Application No.2004-319430 filed on Nov. 2, 2004, the entire contents of which are hereby incorporated by reference.

1. An imaging apparatus, comprising:
a read unit to read image data from a physical document in response to an imaging request from a user;
a user information acquisition unit to acquire user information including a security attribute of the user;
a document information acquisition unit to acquire document information including a security attribute of the physical document;
an operating condition selection unit to determine whether to authorize outputting of the image data read from the physical document based on the user information and the document information by referring to a predetermined rule; and
a log management unit to store the image data in association with the user information without allowing the image data to be output when the document information is not acquired at the document information acquisition unit.

2. The imaging apparatus as claimed in claim 1, wherein the operating condition selection unit includes a rule table describing the predetermined rule pertaining to an imaging authorization standard based on the user security attribute and the document security attribute.

3. The imaging apparatus as claimed in claim 2, wherein when the document information of the physical document is acquired at the document information acquisition unit, the operating condition selection unit prohibits the outputting of the image data, or authorizes the outputting of the image data on condition that tracking information is embedded in the image data depending on a description of the rule table.

4. The imaging apparatus as claimed in claim 1, further comprising an operations control unit to cause the log management unit to stored the image data and report the fact that the document information has not been acquired from the physical document to a system administrator when the document information is not acquired at the document information acquisition unit.

5. The imaging apparatus as claimed in claim 1, wherein when a read request for reading the stored image data is received, the log management unit determines whether to authorize the reading of the stored image data based on the user information of the user making the read request, and when the reading is authorized, the log management unit reads and outputs the stored image data.

6. The imaging apparatus as claimed in claim 5, wherein when the reading of the stored image data is authorized, the log management unit determines whether the image data have been tampered with.

7. The imaging apparatus as claimed in claim 1, wherein when a read request for reading the stored image data is received, the log management unit stores the read request in association with the user information of the user making the read request.

8. The imaging apparatus as claimed in claim 1, wherein the log management unit includes:
a character read unit to extract a portion of the stored image data and convert the extracted portion into a character string; and
a document search unit to access a document management database and search the document management database to determine whether a document that contains a character string matching the converted character string is included within the document management database.

9. The imaging apparatus as claimed in claim 8, wherein when the reading of the stored image data is authorized and a document with a character string matching the converted character string is not included in the document management database, the log management unit outputs the stored image data and a message indicating that a matching document has not been found.

10. The imaging apparatus as claimed in claim 1, wherein the log management unit includes:
a characteristic extraction unit to extract a characteristic of the stored image data; and
a document search unit to access a document management database and search the document management database to determine whether a document having a characteristic matching the extracted characteristic is included within the document management database.

11. The imaging apparatus as claimed in claim 10, wherein when the reading of the stored image data is authorized and a document with a characteristic matching the extracted characteristic is not included in the document management database, the log management unit outputs the stored image data and a message indicating that a matching document has not been found.

12. An imaging system, comprising:
an imaging unit to read image data from a physical document and conduct an imaging job for the physical document in response to an imaging request from a user;
a user profile management unit to acquire a user profile including a security attribute of the user;
a document profile management unit to acquire a document profile including a security attribute of the physical document;
an operation condition management unit to determine whether to authorize outputting of the image data read from the physical document based on the security attribute of the user and the security attribute of the physical document by referring to a rule table that describes a predetermined rule pertaining to imaging; and
a log management unit to receive the image data from the imaging unit and store the image data in association with the user profile when the document profile is not acquired at the document profile management unit;
wherein the imaging unit, the user profile management unit, the document profile management unit, the operating condition selection unit, and the log management unit are interconnected via a network; and
the imaging unit is operable to refrain from conducting the requested imaging job when the document profile is not acquired at the document profile management unit.

13. The imaging system as claimed in claim 12, wherein when an access request for accessing the stored image data is received, the log management unit determines whether to authorize the accessing based on the security attribute of the user making the access request, and when the accessing is authorized, the log management unit transmits the stored image data to the imaging unit via the network.

14. A security management apparatus that is connected to an imaging apparatus via a network, the apparatus comprising:
an operating condition selection unit including a rule table describing a rule pertaining to an imaging authorization standard based on a user security attribute and a document security attribute of a document under security management the operating condition selection unit being configured to refer to the rule table to determine whether to authorize execution of an imaging job for a physical document by the imaging apparatus when document information including the security attribute of the physical document is acquired;
an operations control unit to send an instruction to the imaging apparatus to prohibit the execution of the imaging job when the document information is not acquired; and
a log management unit to receive image data of the physical document from the imaging apparatus and store the image data in association with user information of a user of the imaging apparatus when the document information is not acquired.

15. The security management apparatus as claimed in claim 14, wherein when a read request for reading the stored image data is received, the log management unit determines whether to authorize the reading based on the security attribute of the user making the read request, and when the reading is authorized the log management unit transmits the stored image data to the imaging apparatus.

16. The security management apparatus as claimed in claim 14, wherein the log management unit further includes an access log recording unit to store a read request issued by the user for reading the stored image data, the read request being stored in association with the user information of the user issuing the read request.

17. A security management method, comprising:
reading image data from a physical document in response to an imaging request;
acquiring document information including a security attribute of the physical document;
acquiring user information including a security attribute of a user issuing the imaging request;
determining whether to authorize outputting of the image data read from the physical document based on the user information and the document information by referring to a predetermined rule pertaining to imaging; and
storing the image data of the physical document in association with the user information and refraining from conducting the outputting of the image data requested by the imaging request when the document information is not acquired.

18. The security management method as claimed in claim 17, further comprising:
outputting the image data with tracking information embedded in the image data when the outputting of the image data is authorized.

19. The security management method as claimed in claim 17, further comprising:
outputting the image data and reporting the fact that the outputting of the image data has been conducted when the outputting of the image data is authorized.

20. The security management method as claimed in claim 17, further comprising:
determining whether to authorize accessing of the stored image data when an access request for accessing the stored image data is received, the determination being made based on a security attribute of the user making the access request, and upon authorizing the accessing, outputting the stored image data.

21. The security management method as claimed in claim 17, further comprising:
storing an access request issued by the user for accessing the stored image data, the access request being stored in association with the user information of the user.

22. An article of manufacture having a recording medium that stores an imaging program including an instruction stream for administering an imaging apparatus to execute a process comprising:
generating image data from a physical document in response to an imaging request issued by a user;
acquiring document information including a security attribute of the physical document;
acquiring user information including a security attribute of the user;
determining whether to authorize outputting of the image data of the physical document based on the user information and the document information by referring to a predetermined rule; and
storing the image data in association with the user information and refraining from conducting the outputting of the image data requested by the imaging request when the document information is not acquired from the read document.

23. An article of manufacture having a recording medium that stores a security management program including an instruction stream for administering a security management apparatus connected to an imaging apparatus via a network to execute a process comprising:
acquiring document information including a security attribute of a physical document that is subject to an imaging job by the imaging apparatus that reads image data from the physical document in response to an imaging request issued by a user;
acquiring user information including a security attribute of the user;
determining whether to authorize execution of the imaging job for the physical document based on the user information and the document information by referring to a predetermined rule pertaining to imaging; and
prohibiting the imaging apparatus from conducting the imaging job, receiving the image data from the imaging apparatus, and storing the image data in association with the user information when the document information is not acquired.
